(19) United States
(12) Patent Application Publication
(10) Pub. No.: US 2014/0129077 A1
(43) Pub. Date: May 8, 2014

(54) SCAN TOOL WITH CONFIGURABLE SHORTCUTS

(71) Applicant: SERVICE SOLUTIONS U.S. LLC, Charlotte, NC (US)

(72) Inventors: Reed SELKIRK, Kalamazoo, MI (US); William A. ARNHOLT, Portage, MI (US); William W. WITTLIFF, III, Gobles, MI (US)

(73) Assignee: SERVICE SOLUTIONS U.S. LLC, Charlotte, NC (US)

(21) Appl. No.: 13/668,845

(22) Filed: Nov. 5, 2012

(51) Int. Cl. G06F 17/00

(52) U.S. Cl. 701/31.4

(57) ABSTRACT

A vehicle diagnostic tool and a process of operating a diagnostic tool include communicating with a vehicle in at least one communication protocol. The tool and process further including receiving inputs from a user, displaying information on a display, performing a script of actions associated with a shortcut, performing diagnostic procedures in response to the receiving of inputs from the input device, communicating with the vehicle and performing the script of actions, and storing the script of actions in a memory.

### FIELD OF THE INVENTION

The invention relates generally to an automotive diagnostic tool having configurable shortcuts. Particularly, the invention relates to an automotive diagnostic tool having configurable shortcuts that may be generated by a user and/or generated by another user. More particularly, the invention relates to an automotive diagnostic tool having configurable shortcuts that allow a user to perform desired diagnostic actions in a faster manner and/or with fewer user actions.

### BACKGROUND OF THE INVENTION

Onboard control computers have become prevalent in motor vehicles. Successive generations of onboard control computers have acquired increasing data sensing and retention capability as the electronics have advanced.

Present external diagnostic and display apparatus, known as diagnostic tools, report the data acquired by the onboard control computer itself. Currently in the automotive industry, there are both stand alone and hand-held diagnostic testers or tools used in connection with motor vehicle maintenance and repair. For example, hand-held diagnostic tools have been used to trouble-shoot faults associated with vehicular control units. Diagnostic tools can detect faults based on Diagnostic Trouble Codes or DTCs that are set in the vehicle's onboard control computer. A DTC can be triggered and stored when there is a problem with the vehicle. A technician then retrieves the DTC using a diagnostic tool, repairs the associated problem and then deletes the DTC from the vehicle's computer.

The current diagnostic tools have become very complicated because of the increase in the number of features. It is desirable for a user to configure the tool in a way that helps the technician to operate the tool in a desired faster manner in order to perform vehicle diagnostics. However, the current diagnostic tools fail to provide an easy manner of allowing a user to operate a diagnostic tool in a desired manner faster.

The current diagnostic tool are very limited in how they can be controlled. There is very little control that a user has over the diagnostic tool in order to perform desired vehicle diagnostics. Another problem is that each user may have a different set of expertise and priorities in dealing with the different configurations of a diagnostic tool. For example, a user operating a diagnostic tool may desire to perform a particular desired vehicle diagnostic. In order to perform this particular desired vehicle diagnostic, the user must perform a series of actions that typically includes performing a series of inputs and other interactions with the diagnostic tool interface. For example, the user will have to interact with a series of menus, make a number of selections, provide various input information, and the like. This process can be time-consuming and if repeated multiple times can greatly impact on the efficiency of the user.

Accordingly, it is desirable to provide a method and apparatus that will allow a user greater control in operating a scan tool in a faster manner to perform desired vehicle diagnostics.

### SUMMARY OF THE INVENTION

The foregoing needs are met, to a great extent, by the invention, wherein in one aspect a technique and apparatus are provided that will allow a technician to configure the diagnostic tool to perform desired diagnostic actions in a faster manner and/or with fewer user actions through the use of shortcuts.

In one aspect a vehicle diagnostic tool includes a signal translator that communicates with a vehicle in at least one communication protocol, an input device that receives inputs from a user, a display configured to display information, a processor configured to perform a script of actions associated with a shortcut, the processor configured to receive the inputs from the input device, communicate with the vehicle with the signal translator, and perform diagnostic procedures partly in response to the script of actions, and a memory that stores the script of actions.

In another aspect a process of operating a diagnostic tool includes communicating with a vehicle in at least one communication protocol, receiving inputs from a user, displaying information on a display, performing a script of actions associated with a shortcut, performing diagnostic procedures in response to the receiving of inputs from the input device, communicating with the vehicle and performing the script of actions, and storing the script of actions in a memory.

In another aspect a diagnostic tool includes means for communicating with a vehicle in at least one communication protocol, means for receiving inputs from a user, means for displaying information on a display, means for performing a script of actions associated with a shortcut, means for performing diagnostic procedures in response to the receiving of inputs from the input device, communicating with the vehicle and performing the script of actions, and means for storing the script of actions in a memory.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 illustrates a front view of a diagnostic tool according to an embodiment of the invention.

FIG. 2 is a top view of the diagnostic tool according to an embodiment of the invention.

FIG. 3 illustrates a front view of a diagnostic tool according to another embodiment of the invention.

FIG. 4 is a block diagram of the components of the diagnostic tool according to an embodiment of the invention.

FIG. 5 is a block diagram of modules for the operation and generation of shortcuts in a diagnostic tool according to the invention.

FIG. 6 is a flow diagram of a diagnostic tool illustrating operation of shortcuts implemented in the diagnostic tool according to the invention.

FIG. 7 is a flow diagram of a diagnostic tool illustrating generation of shortcuts implemented in the diagnostic tool according to the invention.

### DETAILED DESCRIPTION

The invention will now be described with reference to the drawing figures, in which like reference numerals refer to like parts throughout. An embodiment in accordance with the invention provides an apparatus and method that will allow a user, such as a technician, to use a diagnostic tool to determine the nature of a problem, and the tool being configurable to include shortcuts.

Manufacturers have programmed their vehicle onboard computers with complicated methods of detecting a variety of problems. However, there are still problems of using the diagnostic tool since there are limitations in the manner a diagnostic tool can be configured. In an embodiment of the invention, the diagnostic tool can be configured to have shortcuts for all the available functions of the diagnostic tool.

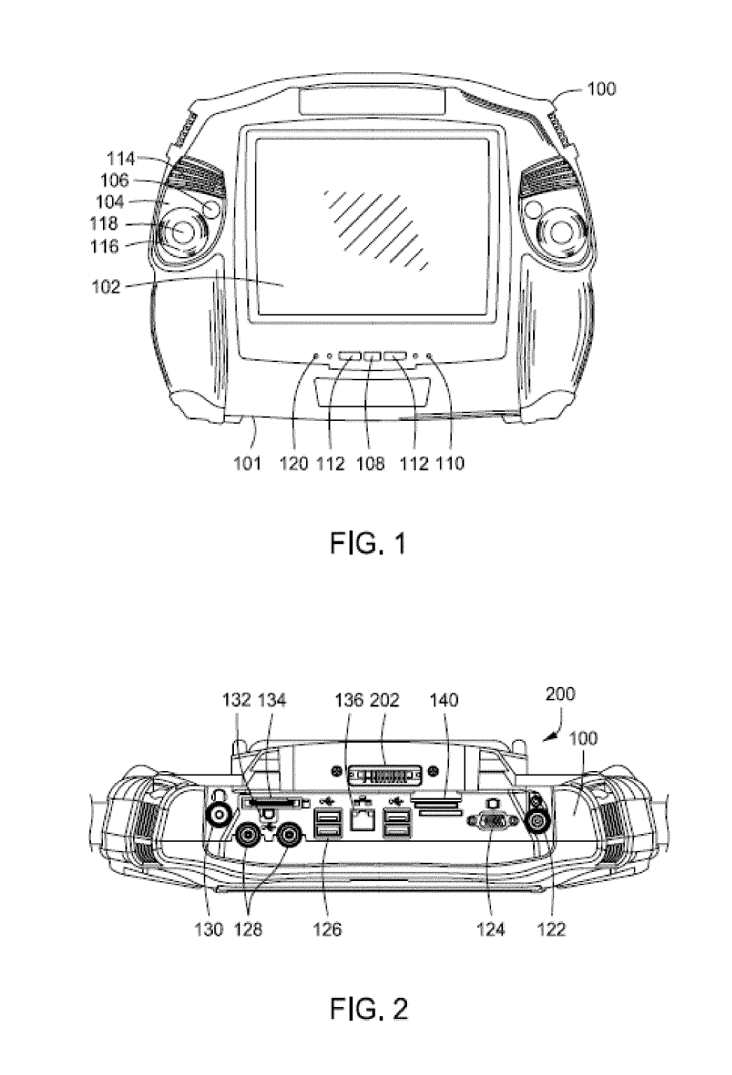

FIG. 1 illustrates a front view of a diagnostic tool 100 according to an embodiment of the invention. An example of the diagnostic tool is the Pegisys® from Service Solutions (Owatonna, Minn.), business unit of a SPX Corporation. The diagnostic tool 100 may include a housing 101, display 102, a scroll device (or input device) 104, a power button 108, LED indicators 110 and function buttons 112. The display can be any type of display including LCD, LED, VGA, OLED, SVGA and other types of displays including touch screen displays. The display may be a colored, non-colored (e.g. gray scale) or a combination of both. The display can display information such as the make, model, year of vehicles that the diagnostic tool can diagnose, the various diagnostic tests the diagnostic tool can run, diagnostic data the diagnostic tool has received, the baseline data of the various components in a vehicle, part images, parts information, and information from remote servers (internet, database information, etc.). Additionally, the display can show videos for the user to view and the accompanying audio can be heard via the built in speakers 114. The speakers can be a single speaker or multiple speakers (as shown) for stereo sound. In one embodiment, the display allows the user to input selection through the touch screen for interactive navigation and selection, wherein the technician can select a menu item by touching the selection on the screen.

The scroll device 104 can be used to scroll through information or menus on the display, such as vehicle information or available diagnostic tests and used to input information. In one embodiment, there is one scroll device 104 and in another embodiment there are two or more scroll devices 104. When two scroll devices 104 are present, the user can have dual controls of the menus or the selections on the display. By having two scroll devices, it will be easier for a technician to use the diagnostic tool regardless if he was left-handed or right-handed. The scroll device may include an “enter” button 118 so that user can select the menu item, for example, a vehicle make, the part information, or a diagnostic test to run. The scroll device 104 also may include a scroll wheel 116 that can rotate around the “enter” button 118. The scroll wheel 116 also may include up, down, left and right arrow controls. The scroll wheel 116 may allow the technician to move an indicator on the screen so that the information, such as menus can be scrolled and a selection on the screen can be made. The scroll wheel 116 may be configured for a fast response or fast scrolling. The scroll device 104 also may include a scroll button 106, such as an “esc” (escape) button or any other button desired by the technician, such as a “back” or “forward” button. The scroll button 106 including any components of the scroll device 104 can be programmed for any desired functionality.

The face of the diagnostic tool 100 may include the power button 108 that allows the technician to power “ON” and “OFF” the diagnostic tool 100. The power button 108 can also be used to put the tool 100 into a standby mode in order to save battery power when not in use. Also on the face of the diagnostic tool there may be LEDs to indicate various status of the functionality of the diagnostic tools, such as wireless connectivity or network connectivity, low battery and any other indicators desired by the technician. The face of the diagnostic tool further may include function buttons 112 that when pressed allows a user to perform a specified function such as controlling the brightness of the display, volume of the speakers or any other function desired by the technician. A microphone 120 may be included and allows the technician to record information such as the noise being made by the vehicle for later analysis or for comparison with stored data. Further, the technician can also record comments or notes during the testing for later retrieval and analysis.

FIG. 2 is an upper view of the diagnostic tool 100 according to an embodiment of the invention. Turning to the connections available on the diagnostic tool 100, the diagnostic tool can be connected to an NC power source via the NC power connector 122. The NC power source powers the diagnostic tool and recharges the diagnostic tool's internal battery (not shown). A VGA video connector 124 may be included and allow the information on the diagnostic tool 100 to be displayed on an external display, such as a display on a personal computer. Other display connector types can include HDMI for better graphics and sound.

A series of host USB (universal serial bus) connectors 126 may be included to couple additional devices to the diagnostic tool 100. In one embodiment, there are four connectors, but more or less connectors are contemplated by the invention. Additional devices can add functionality to the diagnostic tool or allow the diagnostic tool 100 to add functionality to another device, such as a VCI (vehicle communication interface) 200. The functionality can include communications, printing, memory storage, video and other functionality. A two-channel scope connection 128 may be included and allows for a scope to be connected to the diagnostic tool 100. The scope allows for various measurement of signals such as volts, ohms, dwell, duty cycle, peak to peak, peak volts, injector pulse width, injector on time, firing kV, burn kV, burn voltage and other measurement of signals.

A stereo headphone connection 130 may be included and allows the technician to add a headphone to the diagnostic tool 100. A USB device slot 132 may be included and adds functionality to the diagnostic tool by another device or adds functionality of the diagnostic tool to another device. An express card slot 134 may be provided to add functionality, such as a wireless modem, memory, TV tuner, networking, mouse, remote control and other functionalities to the diagnostic tool 100. An Ethernet connector 136 may be included and allows for network connection with the diagnostic tool 100 in order to transfer data to and from the diagnostic tool to a remote device such as a server or personal computer. SDIO (Secure Digital Input Output) 140 card slots may be provided on the diagnostic tool 100 to provide still additional functionality such as receivers, Wi-Fi or Bluetooth adapters, modems, Ethernet adapters, barcode readers, IrDA adapters, FM radio tuners, TV tuners, RFID readers, and mass storage media such as hard drives and flash drives. The connections are not limited to what are shown in FIG. 2, but additional connectors are contemplated such as Firewire, HDMI, and serial connections.

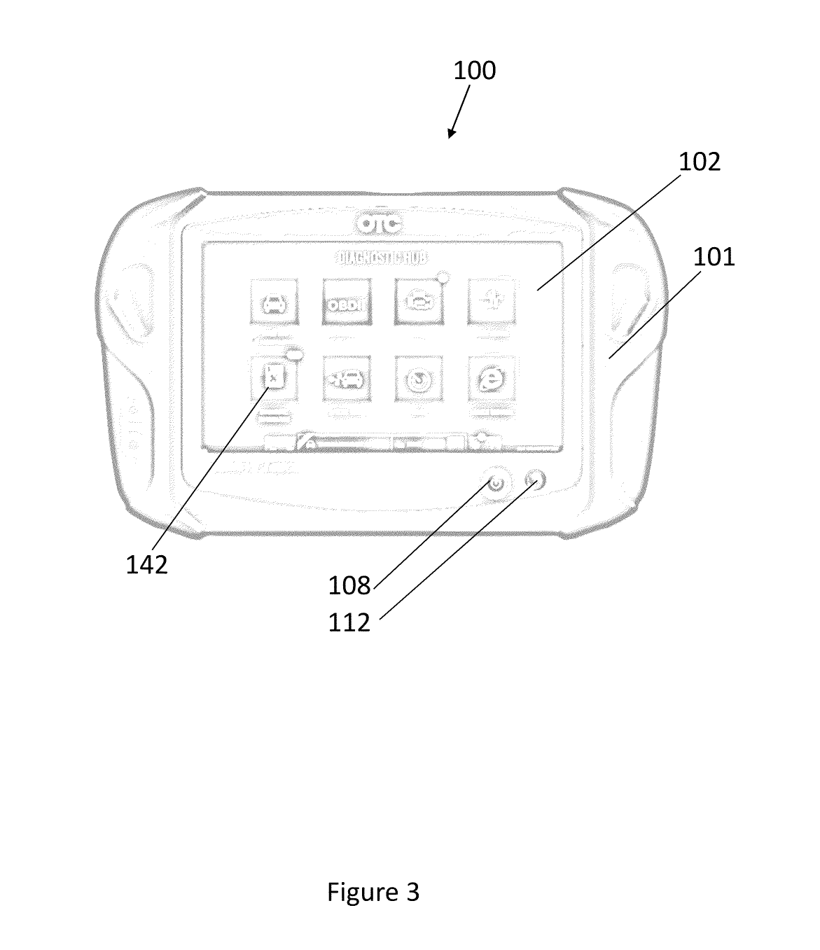

FIG. 3 illustrates a front view of a diagnostic tool according to another embodiment of the invention. FIG. 3 illustrates a front view of another embodiment the diagnostic tool 100 according to an embodiment of the invention. This embodiment of the diagnostic tool 100 may include a housing 101, display 102, a power button 108, and a function button 112. The display can be any type of display including LCD, LED, VGA, OLED, SVGA and other types of displays. In this embodiment the display 102 may be touch screen display with icons 142.

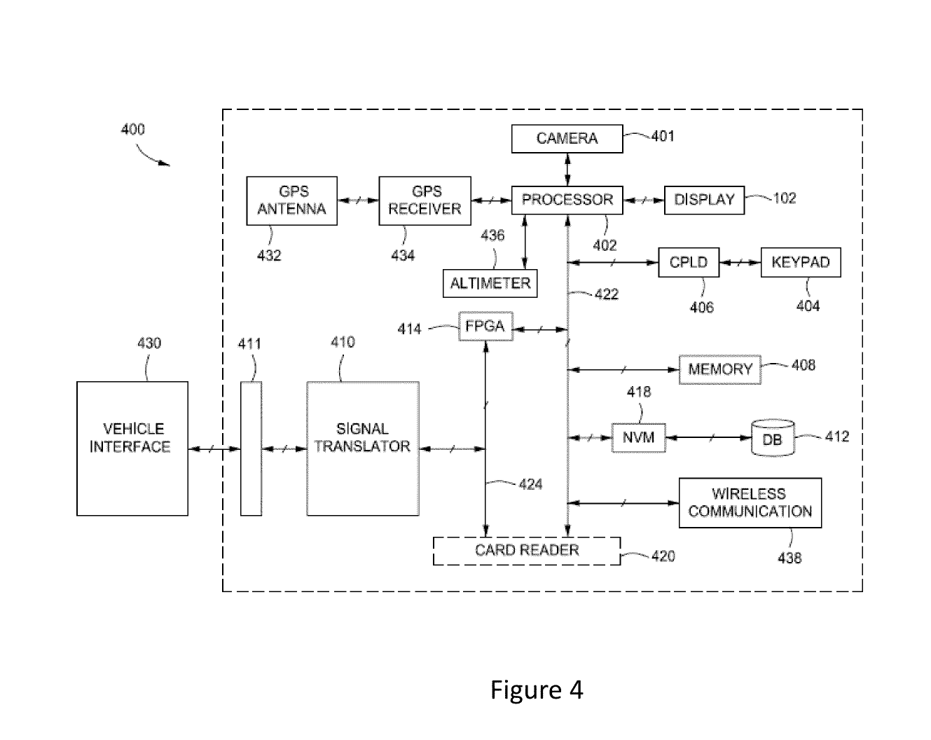

FIG. 4 is a block diagram of the components of the diagnostic tool 100 according to an embodiment of the invention. In FIG. 4, the diagnostic tool 100 according to an embodiment of the invention may include a smart camera 401, a processor 402, a field programmable gate array (FPGA) 414, a first system bus 424, the display 102, a complex programmable logic device (CPLD) 406, the input device in the form of a keypad 404 (scroll device), a memory subsystem 408, an internal non-volatile memory (NVM) 418 having the database 412, a card reader 420 (optional), a second system bus 422, a connector interface 411, a selectable signal translator 410, a GPS antenna 432, a GPS receiver 434, an optional altimeter 436 and wireless communication circuit 438. A vehicle communication interface 430 of the vehicle under test is in communication with the diagnostic tool 100 through connector interface 211 via an external cable (not shown).

Selectable signal translator 410 may be included and communicates with the vehicle communication interface 430 through the connector interface 411. Signal translator 410 conditions signals received from an ECU unit through the vehicle communication interface 430 to a conditioned signal compatible with diagnostic tool 100. Signal translator 410 can communicate with, for example, the following communication protocols: J1850 (VPM and PWM), ISO 9141-2 signal, communication collision detection (CCD) (e.g., Chrysler collision detection), data communication links (DCL), serial communication interface (SCI), Controller Area Network (CAN), Keyword 2000 (ISO 14230-4), OBD II or other communication protocols that are implemented in a vehicle.

The circuitry to translate and send in a particular communication protocol can be selected by FPGA 414 (e.g., by tri-stating unused transceivers) or by providing a keying device that plugs into the connector interface 411 that is provided by diagnostic tool 100 to connect diagnostic tool 100 to the vehicle communication interface 430. Signal translator 410 may be also coupled to FPGA 414 and the card reader 420 via the first system bus 424. FPGA 414 transmits to and receives signals (i.e., messages) from the ECU unit through signal translator 410.

The FPGA 414 may be coupled to the processor 402 through various address, data and control lines by the second system bus 422. FPGA 414 is also coupled to the card reader 420 through the first system bus 424. The processor 402 may also be coupled to the display 102 in order to output the desired information to the user. The processor 402 communicates with the CPLD 406 through the second system bus 422. Additionally, the processor 402 may be programmed to receive input from the user through the user interface 404 via the CPLD 406. The CPLD 406 may provide logic for decoding various inputs from the user of the diagnostic tool 100 and also provides glue-logic for various other interfacing tasks.

Memory subsystem 408 and internal non-volatile memory 418 may be coupled to the second system bus 422, which allows for communication with the processor 402 and FPGA 414. Memory subsystem 408 can include an application dependent amount of dynamic random access memory (DRAM), a hard drive, and/or read only memory (ROM). Software to run the diagnostic tool 100 can be stored in the memory 408 or 418, including any other database. The database 412 can include diagnostic information and other information related to vehicles.

Internal non-volatile memory 418 can be an electrically erasable programmable read-only memory (EEPROM), flash ROM, or other similar memory. Internal non-volatile memory 418 can provide, for example, storage for boot code, self-diagnostics, various drivers and space for FPGA images, if desired. If less than all of the modules are implemented in FPGA 414, memory 418 can contain downloadable images so that FPGA 414 can be reconfigured for a different group of communication protocols.

A GPS antenna 432 and GPS receiver 434 can be included and may be mounted in or on the housing 101 or any combination thereof. The GPS antenna 432 electronically couples to the GPS receiver 434 and allows the GPS receiver to communicate (detects and decodes signals) with various satellites that orbit the Earth. In one embodiment, the GPS antenna and GPS receiver are one device instead of two. The GPS receiver 434 and GPS antenna 432 may electronically couple to the processor 402, which may be coupled to memory 408, NVM 418 or a memory card in the card reader 420. The memories can be used to store cartographic data, such as electronic maps. The diagnostic tool can include all the maps for the U.S. (or country of use), North America or can have the region or state where the diagnostic tool is located. In alternative embodiments, the diagnostic tool can have all the maps of the world or any portion of the world desired by the user. This allows the diagnostic tool to be a GPS device so that a driver can drive from one location to another. The maps may be over lay or may incorporate traffic, local events, and location of other GPS devices (smart phones) and other information that can be useful to the technician. By being able to locate other diagnostic tools with GPS, then the technicians may be able to use the diagnostic tools to locate each other in order to conduct a meeting or have a social event.

The GPS receiver communicates with and “locks on” to a certain number of satellites in order to have a “fix” on its global location. Once the location is fixed, the GPS receiver, with the help of the processor, can determine the exact location including longitude, latitude, altitude, velocity of movement and other navigational data of the diagnostic tool 100.

Should the GPS receiver be unable to lock onto the minimum number of satellites to determine the altitude or unable to determine the altitude for any reason, the altimeter 436 can be used to determine the altitude of the diagnostic tool 100. The altimeter 436 is electronically coupled to the processor 402 and can provide the altitude or elevation of the diagnostic tool 100. The altimeter 436 can be coupled to a barometric pressure sensor (not shown) in order to calibrate the elevation measurements determined by the altimeter. The sensor can be positioned interior or exterior to the housing 101 of the diagnostic tool 100. Minor atmospheric pressure changes can affect the accuracy of the altimeter, thus, diagnostic tool can correct for these changes by using the sensor in conjunction with the altimeter along with a correction factor known in the art.

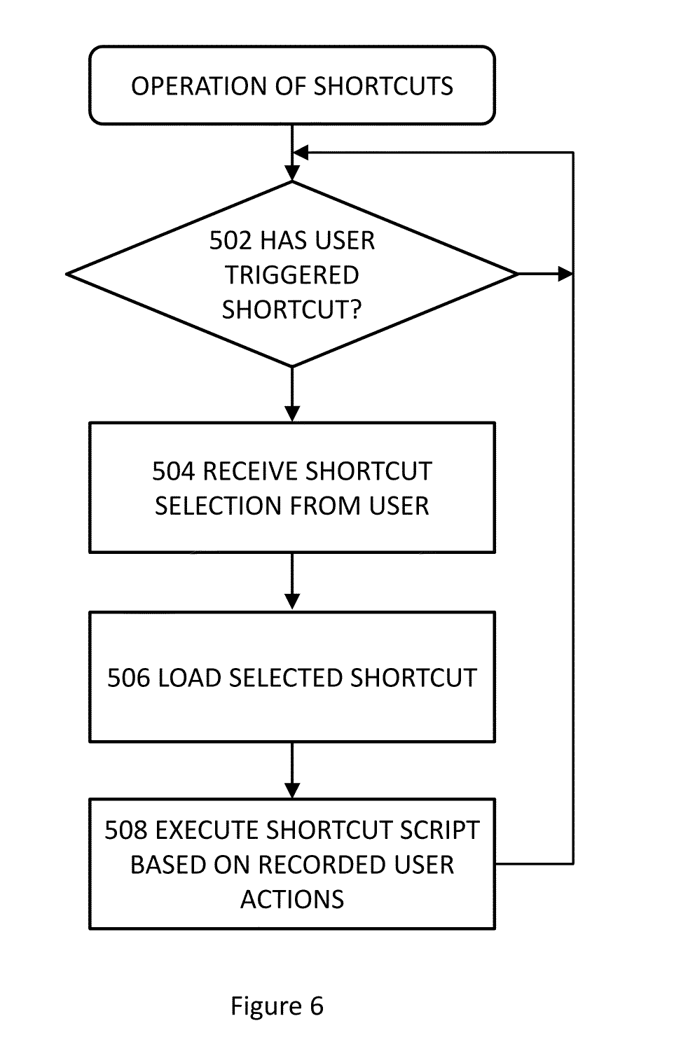

Wireless communication circuit 438 communicates with the processor 402 via the second bus system 422. The wireless communication circuit can be configured to communicate via RF (radio frequency), satellites, cellular phones (analog or digital), Bluetooth®, Wi-Fi, Infrared, ZigBee, Local Area Networks (LAN), WLAN (Wireless Local Area Network), other wireless communication configurations and standards or a combination thereof. The wireless communication circuit 438 allows the diagnostic tool to communicate with other devices wirelessly such as with a remote computing device 500 (FIG. 6) having remote databases. The wireless communication circuit 438 includes an antenna built therein and being housed within the housing 101 or can be externally located on the housing 101.

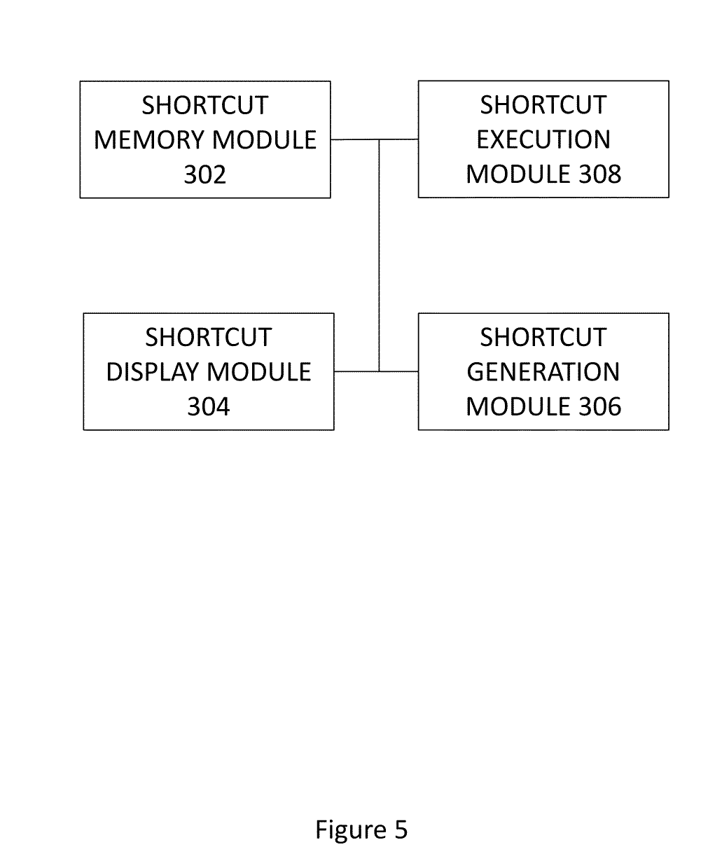

FIG. 5 is a block diagram of modules for the operation and generation of shortcuts in a diagnostic tool according to the invention. The diagnostic tool 100 of the invention can be configured to have shortcuts as specified by the user. The user configurable shortcuts implemented in the diagnostic tool 100 will allow the user to operate the diagnostic tool 100 faster, diagnose the vehicle faster and thus be able to repair the vehicle faster. It is possible to have a programmable key to perform the shortcuts in a user specified manner.

As may be appreciated by those skilled in the art, the illustrated structure shown in FIG. 5 is a logical structure and not a physical one. Accordingly, the illustrated modules can be implemented by employing various hardware and software components. In addition, functions of two or more of the logical components can be implemented as a single module that provides functionality for both components. Moreover, each one of the functions of the modules may be implemented in multiple modules or different modules. In one embodiment, the components are implemented as software program modules executed by the processor 402.

A shortcut may be implemented as a rule or pattern that identifies how a certain input sequence may be mapped to a replacement input sequence according to a defined procedure. The mapping process instantiates and transforms a shortcut use into a specific sequence known as shortcut expansion. In particular, plural user input actions, selection actions, scrolling actions, mouse actions, keypad actions and the like input to the user interface 404 may be mapped and replaced by the shortcut. The user shortcuts allow short sequence user input actions, selection actions, scrolling actions, mouse actions, keypad actions and the like to replace usually more time-consuming, sequences of plural user input actions, selection actions, scrolling actions, mouse actions, keypad actions and the like. In this way, frequently used or repetitive sequences of plural user input actions, selection actions, scrolling actions, mouse actions, keypad actions and the like can be automated.

The shortcuts may be created by carrying out the sequence of plural user input actions, selection actions, scrolling actions, mouse actions, keypad actions and the like and letting a shortcut generation module 306 record the actions. An underlying shortcut programming language, such as a scripting language, may have direct access to the features of the application.

The scripting language or script language may be a programming language that supports the writing of scripts to automate the execution of tasks which could alternatively be executed by a human operator. Scripts can be written and executed “on-the-fly” and may be written without explicit need to compile and link steps. The scripts may be generated or modified by the user. A scripting language may be interpreted from source code or bytecode. On the other hand, scripts may be written in a compiled language and distributed in machine code form.

Referring to FIG. 5, the invention may include a shortcut memory module 306. The shortcut memory module 306 may be implemented as part of the memory 408, 412, 418 and/or the like of the diagnostic tool 100, may be implemented in conjunction with a memory card connected to card reader 420, may be implemented as part of another system connected through wireless communication device 438, or the like. The shortcut memory module 306 may store various shortcuts for use by the user of the diagnostic tool 100.

More specifically, the shortcut memory module 306 may store the name of the shortcut, date and time the shortcut was generated, the manner in which the shortcut is to be displayed, manner which the shortcut is accessed by the user, a script that the shortcut executes and the like. The script that the shortcut executes may be a series of inputs including plural user input actions, selection actions, scrolling actions, mouse actions, keypad actions and the like.

The invention may include a shortcut display module 302. The shortcut display module 302 may display on the display 102 one or more of the shortcuts that are stored in the shortcut memory module 306. In particular, the shortcut display module 302 may display the shortcuts as icons, function buttons, menu item, folder item, or the like. Selection of one of the icons, function buttons, menu item, folder item, or the like will execute the shortcut associated with the same in conjunction with a shortcut execution module 308.

The shortcut display module 304 may also display a menu to allow for the shortcut generation process, allow for the editing of a shortcut, allow for the deletion of a shortcut, allow for a listing of the shortcuts stored in the shortcut memory module 302, allow for adding a shortcut from an outside source, allow for a user to send a shortcut to another user, or the like. Additionally, the shortcut display module 304 may include the ability to generate one or more folders that store shortcuts. In that regard, a user can sort and review the shortcuts that are stored in the shortcut memory module 302 when utilizing the shortcut display module 304. Furthermore, the user can review the shortcuts that are stored in shortcut memory module 302 and store them in a USB memory or memory card of the diagnostic tool 100 so that they may use them in another diagnostic tool 100. Furthermore as noted above, the user can also take the shortcuts stored in the shortcut memory module 302 and send them to another user via e-mail, or some other communication process.

The shortcut execution module 308 may execute a particular shortcut in response to the user request to execute a particular shortcut. When executing the particular shortcut, the shortcut execution module 308 may access a particular shortcut from the shortcut memory module 302. From the shortcut memory module 302, the shortcut execution module 308 may execute the script associated with a particular shortcut and perform the various plural user input actions, selection actions, scrolling actions, mouse actions, keypad actions and the like associated with the script. Once execution of the script is complete, the shortcut execution module 308 may return control of the diagnostic tool 100 back to the user.

A shortcut generation module 306 may be used to create a shortcut and store it in the shortcut memory module 302. The shortcut generation module 306 may be accessed through the shortcut display module 304 as part of a menu selection or the like. Once the shortcut generation module 306 is in a mode of generating a shortcut, the shortcut generation module 306 may record the users plural user input actions, selection actions, scrolling actions, mouse actions, keypad actions and the like. A user can stop the recording process of the shortcut generation module 306 once they have completed all the actions associated with a particular shortcut. The newly recorded shortcut may be stored in the shortcut memory module 302. The shortcut generation module 308 may request a name for the shortcut. The shortcut generation module 308 may also request a manner in which the shortcut will be displayed on the display 102 including being displayed as an icon, displayed as a menu item, or the like. The shortcut generation module 308 may also request a manner in which the shortcut is used by the diagnostic tool 100 including use with a programmable key, use with a function key and the like. Thereafter the newly generated shortcut may be stored in the shortcut memory module 302 and is ready for execution by the shortcut execution module 308 and may further be displayed by the shortcut display module 304.

Accordingly, the shortcut generation module 306 records user actions for playback by the shortcut execution model 308 at a later time. The shortcut display module 304 displays the shortcuts stored in the shortcut memory module 302. The main advantage of using a shortcut is that it allows a user to easily perform complex operations much faster and with less effort.

FIG. 6 is a flow diagram of a diagnostic tool illustrating operation of shortcuts implemented in the diagnostic tool according to the invention. In particular, as shown in FIG. 6, when a user desires to execute a shortcut process 502, the user may select a shortcut that is displayed on the display 102 associated with a particular input action in conjunction with keypad 404 operation, or the like to trigger the shortcut execution. The particular input action or the like selects the particular shortcut to be executed as shown by process 504. The particular shortcut and the action to be executed may be stored as described above in the shortcut memory module 302.

In process step 506, the particular shortcut stored in shortcut memory module 302 may be accessed by the shortcut execution module 308. Shortcut execution module 308 may execute the script associated with the particular executing shortcut. Thereafter, the shortcut execution module 308 may follow the script of implementing plural user input actions, selection actions, scrolling actions, mouse actions, keypad actions and the like consistent with the script as indicated by process 508. Once the script of plural user input actions, selection actions, scrolling actions, mouse actions, keypad actions and the like has been implemented, the process set forth in FIG. 6 may end.

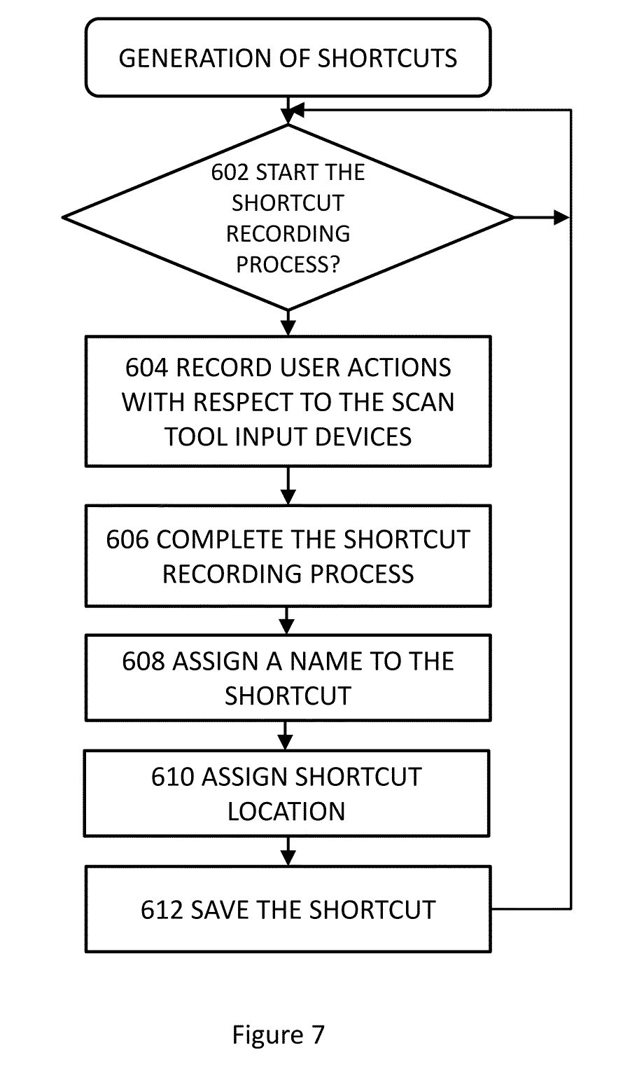

FIG. 7 is a flow diagram of a diagnostic tool illustrating generation of shortcuts implemented in the diagnostic tool according to the invention. In conjunction with shortcut generation module 306, at process 602, the user can initiate a shortcut recording process. The shortcut recording process can be initiated through a menu selection process or the like provided by shortcut display module 304. For example the shortcut display module 304 may include a menu or button for adding a new shortcut. The shortcut display module 304 may further include a menu or button for recording a new shortcut. Once the user has requested a new shortcut and started the recording process for the new shortcut, the user can then start to provide plural user input actions, selection actions, scrolling actions, mouse actions, keypad actions and the like associated with the desired shortcut to generate the same in conjunction with process 604.

Once the user has completed the various actions for the new shortcut, the user may again interact with display 102, input 404, and the like generated by shortcut display module 304 to stop the recording process and complete the shortcut generation in conjunction with process 606.

Next, the shortcut generation module 306 may request that the user provide a name for the shortcut in order to help the user recognize the memorized shortcut in conjunction with process 608. The shortcut generation module 306 may also request the user provide a manner in which the shortcut will be accessible in the diagnostic tool 100. For example, the user can determine that the shortcut should be listed in a menu, as an icon, or the like in conjunction with process 610. Finally, in conjunction with process 612 the shortcut may be saved to shortcut memory module 302.

As a particular example, a user may have a tendency to conduct maintenance on a fleet of similar vehicles. In particular, this user may find it useful to perform a particular diagnostic process for the vehicles of this fleet. In this regard, the user can create a shortcut that performs the desired particular diagnostic process for the type of vehicle in this fleet. The user can generate the shortcut utilizing the shortcut generation module 306 in conjunction with the process described above with respect to FIG. 7. The process may be, for example, an oil light reset procedure. The user can then follow the process steps of FIG. 7 to generate a shortcut for the oil light reset procedure. In particular, the user can perform the actions associated with an oil light reset procedure while recording the actions utilizing the shortcut generation module 306. The user can then save the shortcut as “Oil Light Reset Procedure For Model X” in the shortcut memory module 302. Additionally, the user can utilize the shortcut display module 304 to create an icon for the “Oil Light Reset Procedure For Model X” on the display 102 of the diagnostic tool 100. When the user desires to perform the “Oil Light Reset Procedure For Model X,” the user may simply tap the icon “Oil Light Reset Procedure For Model X” on the display 102. Thereafter, the shortcut execution module 308 may generate all of the scripted actions associated with an oil light reset procedure. Finally, the user may want to share the “Oil Light Reset Procedure For Model X” shortcut with a coworker and can through the shortcut memory module 302 and the shortcut display module 304 save the “Oil Light Reset Procedure For Model X” shortcut to a USB flash drive to share the coworker or e-mail the “Oil Light Reset Procedure For Model X” shortcut to the coworker. Accordingly, the user is able to simply automate the multistep process of conducting an oil light reset procedure such that it requires a limited action by the user to execute the oil light reset procedure. Note, that the above example of generating a shortcut for an oil light reset procedure is merely exemplary. Any procedure that may be implemented by the diagnostic 100 may be configured for a particular shortcut.

Thus, the invention allows a user to configure the diagnostic tool to generate their favorite shortcuts. These shortcuts allow fast access to commonly used applications that require some setup. Since diagnostic tool users do not use diagnostic tools in the same manner, the invention enables the user to generate a fast diagnostic tool that suits the user's work habits. Additionally, the shortcuts can be used for training purposes such that a trainer can quickly go through the use of the diagnostic tool without having to go through lengthy set up procedures. Accordingly, the invention allows for an automotive diagnostic tool to have configurable shortcuts. Additionally, the invention allows a diagnostic tool to have configurable shortcuts that may be generated by a user and/or generated by another user. Furthermore, the invention allows an automotive diagnostic tool to have configurable shortcuts that allow a user to perform desired diagnostic actions in a faster manner and/or with fewer user actions.

The invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The invention can include the computer-readable medium having stored thereon a data structure including a plurality of fields containing data representing the techniques of the invention.

An example of a computer, but not limited to this example of the computer, that can read computer readable media that includes computer-executable instructions of the invention includes a processor that controls the computer. The processor uses the system memory and a computer readable memory device that includes certain computer readable recording media. A system bus connects the processor to a network interface, modem or other interface that accommodates a connection to another computer or network such as the Internet. The system bus may also include an input and output interface that accommodates connection to a variety of other devices.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A vehicle diagnostic tool comprising:
a signal translator that communicates with a vehicle in at least one communication protocol;
an input device that receives inputs from a user;
a display configured to display information;
a processor configured to perform a script of actions associated with a shortcut;
the processor configured to receive the inputs from the input device, communicate with the vehicle with the signal translator, and perform diagnostic procedures partly in response to the script of actions; and
a memory that stores the script of actions.

2. The vehicle diagnostic tool according to claim 1 wherein the script of actions comprise at least one of scroll actions, keypad actions, input actions, selection actions, and mouse actions.

3. The vehicle diagnostic tool according to claim 1 wherein the performance of script actions is based on an input of one of a selection of an icon, selection of the menu item, selection of programmable key, selection of a function key, and selection of a folder item associated with the shortcut.

4. The vehicle diagnostic tool according to claim 1 wherein the shortcut is at least one of displayed on the display as an icon, displayed on the display as menu item, associated with a programmable key, listed in a folder, and associated with a function key.

5. The vehicle diagnostic tool according to claim 1 wherein the input device is configured to determine when a user desires to have the processor perform the script actions associated with the shortcut in response to interaction with at least one icon, menu item, programmable key, item listed in a folder, and function key.

6. The vehicle diagnostic tool according to claim 1 wherein the processor is configured to record inputs by a user received by the input device and generate the script actions based on the inputs by the user.

7. The vehicle diagnostic tool according to claim 1 wherein the script of actions and associated shortcut are configured to be one of stored in a file, stored on a flash drive, edited by a user, deleted by user, loaded by user, and transmitted by user.

8. A process of operating a diagnostic tool comprising:
communicating with a vehicle in at least one communication protocol;
receiving inputs from a user;
displaying information on a display;
performing a script of actions associated with a shortcut;
performing diagnostic procedures in response to the receiving of inputs from the input device, communicating with the vehicle and performing the script of actions; and
storing the script of actions in a memory.

9. The process according to claim 8 wherein the script of actions comprise at least one of scroll actions, keypad actions, input actions, selection actions, and mouse actions.

10. The process according to claim 8 wherein the performing the script actions is based on an input of one of a selection of an icon, selection of the menu item, selection of programmable key and selection of a folder item associated with the shortcut.

11. The process according to claim 8 further comprising at least one of displaying the shortcut on the display as an icon, displaying the shortcut on the display as menu item, associating the shortcut with a programmable key, displaying the item in a list in a folder, and associating the shortcut with a function key.

12. The process according to claim 8 further comprising determining when a user desires to have the processor perform the script actions associated with the shortcut in response to interaction with at least one icon, menu item, programmable key, item in a folder, and function key.

13. The process according to claim 8 further comprising recording inputs by a user received by an input device and generating the script actions based on the inputs by the user.

14. The process according to claim 8 further comprising at least one of storing the script of actions in a file, storing the script of actions on a flash drive, editing the script of actions by a user, deleting the script of actions by user, loading the script of actions by user, and transmitting the script of actions.

15. A diagnostic tool comprising:
means for communicating with a vehicle in at least one communication protocol;
means for receiving inputs from a user;
means for displaying information on a display;
means for performing a script of actions associated with a shortcut;
means for performing diagnostic procedures in response to the receiving of inputs from the input device, communicating with the vehicle and performing the script of actions; and
means for storing the script of actions in a memory.

16. The vehicle diagnostic tool according to claim 15 wherein the script of actions comprise at least one of scroll actions, keypad actions, input actions, selection actions, and mouse actions.

17. The vehicle diagnostic tool according to claim 15 wherein the means for performing the script actions is based on an input of one of a selection of an icon, selection of the menu item, selection of programmable key and selection of a folder item associated with the shortcut.

18. The vehicle diagnostic tool according to claim 15 further comprising at least one of means for displaying the shortcut on the display as an icon, means for displaying the shortcut on the display as menu item, means for associating the shortcut with a programmable key, means for displaying the shortcuts as an item in a folder, and means for associating the shortcut with a function key.

19. The vehicle diagnostic tool according to claim 15 further comprising means for determining when a user desires to have the processor perform the script actions associated with the shortcut in response to interaction with at least one icon, menu item, programmable key, item listed in a folder, and function key.

20. The vehicle diagnostic tool according to claim 15 further comprising means for recording inputs by a user received by an input device and means for generating the script actions based on the inputs by the user.

21. The vehicle diagnostic tool according to claim 15 further comprising at least one of means for storing the script of actions in a file, means for storing the script of actions on a flash drive, means for editing the script of actions by a user, means for deleting the script of actions by user, means for loading the script of actions by user, and means for transmitting the script of actions.
